(19) United States
(12) Patent Application Publication
(10) Pub. No.: US 2025/0306185 A1
(43) Pub. Date: Oct. 2, 2025

(54) Method and Apparatus for Improving a Time-of-Flight Calculation

(71) Applicant: Bayerische Motoren Werke Aktiengesellschaft, Muenchen (DE)

(72) Inventors: Daniel Kuelzer, Muenchen (DE); Daniel Knobloch, Los Gatos, CA (US); Thorsten Knott, Tuntenhausen (DE)

(21) Appl. No.: 18/862,156

(22) PCT Filed: Feb. 24, 2023
(86) PCT No.: PCT/EP2023/054683

§ 371 Date: Oct. 31, 2024

(30) Foreign Application Priority Data
May 18, 2022 (DE) 10 2022 112 428.2

(51) Int. Cl. G01S 7/4865; G01S 17/931

(52) U.S. Cl. CPC G01S 7/4865; G01S 17/931

(57) ABSTRACT

A method for improves a time-of-flight (ToF) calculation between a user terminal and a plurality of transponders. The method includes receiving, from the user terminal, information about a final data distribution at a first transponder of the plurality of transponders. The method also includes, sending, from the first transponder, the information about the final data distribution to a processing unit.

The present application is the U.S. national phase of PCT Application PCT/EP2023/054683 filed on Feb. 24, 2023, which claims priority of German patent application No. 10 2022 112 428.2 filed on May 18, 2022, the entire contents of which are incorporated herein by reference.

### TECHNICAL FIELD

Exemplary embodiments disclosed herein relate to a method for improving a time-of-flight calculation, a computer program, an apparatus and a vehicle, in particular but not exclusively to a concept for delivering information about a final data distribution from a transponder.

### BACKGROUND

Entry to a vehicle can be gained by means of ultra-wideband (UWB), for example. Said entry can be effected according to the Digital Key Release 3, Technical Specification CCC-TS-101, Car Connectivity Consortium, version 1.0.0 (also referred to as the CCC standard hereinbelow). Among other things, this standard encompasses the communication of different delays of signals exchanged between a transponder and a user terminal (UE).

For a time-of-flight (ToF) calculation, an applicable processor of a transponder requires a large amount of information about signals exchanged between the UE and the transponder. Among other things, the transponder requires a Final_Data message (FDN; see table 20-5: Final_DATA message and its parameters in the CCC standard) in order to be able to perform a ToF calculation. If the FDN sent by the UE is not received, the transponder cannot perform a ToF calculation. The FDN can sometimes require a larger link budget than other messages exchanged between the transponder and the UE, however. This can result in the probability of a transmission of the FDN being erroneous increasing, meaning that a TOF calculation cannot be performed by the transponder. By way of example, a different type of packet can result in the probability of receiving the FDN being lower than receiving a POLL or Final (see table 20-2: Mapping of Slots to UWB Ranging Packets in the CCC standard) on a UWB interface.

There is therefore a need to improve a ToF calculation, in particular reception of an FDN.

### SUMMARY

The above-described need, as well as others, are met by the methods, the apparatus, the computer program and the vehicle according to the independent claims.

Exemplary embodiments are based on the central idea that a ToF calculation can be improved by virtue of information about a final data distribution (in particular an FDN) being sent to a processing unit, which can then perform a ToF calculation, by a transponder. As a result, a ToF calculation can be performed by a processing unit that has not received an FDN from a UE, for example. This can render a ToF calculation possible for a multiplicity of transponders even if only one transponder has received an FDN, for example.

Exemplary embodiments relate to a method for improving a time-of-flight calculation between a user terminal and a plurality of transponders. The method comprises receiving, from the user terminal, information about a final data distribution (for example receiving an FDN) at one transponder of the plurality of transponders and sending, from the transponder, the received information to a processing unit. This allows the processing unit to perform a ToF calculation, for example for the transponder and/or another transponder, in particular even if the processing unit has not received the FDN from the UE directly.

In one exemplary embodiment, the method can further comprise receiving, from the processing unit, information about a performed ToF calculation. This allows the transponder to be notified that a ToF calculation has been performed for the transponder. By way of example, this allows the transponder to terminate an attempt to receive an FDN.

In one exemplary embodiment, the method can further comprise decrypting the received information before it is sent. This allows, in particular, a processing unit to use the FDN for ToF calculation even if a key for decrypting the FDN is not known to the processing unit, as it may already have been decrypted by the transponder.

In one exemplary embodiment, the method can further comprise sending, from the transponder, information for performing a ToF calculation to the processing unit. This allows the transponder to inform the processing unit for example that an FDN has not been received and a ToF calculation is meant to be performed by the processing unit. Optionally or alternatively, the transponder can also send other parameters required for a ToF calculation to the processing unit, for example a time of transmission or intervals of time for a POLL or Final message according to the CCC standard.

In one exemplary embodiment, the processing unit may be encompassed by another transponder of the plurality of transponders. This allows the ToF calculation to be performed in particular by one transponder of the plurality of transponders, as a result of which costs can be minimized.

Exemplary embodiments relate to a method for improving a time-of-flight calculation between a user terminal and a plurality of transponders. The method comprises receiving, from one transponder of the plurality of transponders, information about a final data distribution at a processing unit and performing a ToF calculation on the basis of the information about the final data distribution for the other transponder of the plurality of transponders. This allows a processing unit that has not received an FDN from a UE to perform a ToF calculation by means of the FDN that a transponder has received and has sent to the processing unit.

In one exemplary embodiment, the method can further comprise sending, from the processing unit, information about the performed ToF calculation to one transponder of the plurality of transponders. This allows the transponder to be notified that a ToF calculation has been performed for the transponder. By way of example, this allows the transponder to terminate an attempt to receive an FDN.

In one exemplary embodiment, the processing unit may be encompassed by another transponder of the plurality of transponders. This allows the ToF calculation to be performed in particular by one transponder of the plurality of transponders, as a result of which costs can be minimized.

In one exemplary embodiment, the method can further comprise receiving, from the transponder, information for performing a ToF calculation at the processing unit. This allows the processing unit to receive from the transponder for example information indicating that an FDN has not been received and a ToF calculation is meant to be performed by the processing unit. Optionally or alternatively, the processing unit can also receive other parameters required for a ToF calculation from the transponder, for example a time of transmission or intervals of time for a POLL or Final message according to the CCC standard.

In one exemplary embodiment, the method can further comprise sending a request for the information about the final data distribution to the transponder of the plurality of transponders. This allows the data processing unit to request the FDN from one transponder of the plurality of transponders, for example if the data processing unit has not received an FDN from the UE.

Exemplary embodiments relate to a method for improving a time-of-flight calculation between a user terminal and a plurality of transponders. The method comprises sending, from one transponder, information for performing a ToF calculation to a processing unit. This allows a transponder to send parameters required for a ToF calculation to a processing unit, for example a time of transmission or intervals of time for a POLL or Final message according to the CCC standard.

Exemplary embodiments also provide a computer program for carrying out one of the methods described herein when the computer program runs on a computer, a processor or a programmable hardware component.

Another exemplary embodiment is an apparatus for improving a ToF calculation. The apparatus comprises one or more interfaces for communication with other communication devices (e.g. for communication with at least one from a user terminal, a transponder or a processing unit) and a control module designed to carry out at least one of the methods described herein.

Exemplary embodiments moreover provide a vehicle having an apparatus as described herein. In one exemplary embodiment, the processing unit may be encompassed by a central computing unit of the vehicle. This allows in particular a ToF calculation to be performed by a central processor and then sent to at least one transponder of the plurality of transponders.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of an example of a method for improving a ToF calculation;

FIG. 2 shows a schematic representation of another example of a method for improving a ToF calculation;

FIG. 3 shows a schematic representation of another example of a method for improving a ToF calculation;

FIG. 4 shows a block diagram of an exemplary embodiment of an apparatus for improving a ToF calculation; and

FIG. 5 shows a vehicle having an apparatus according to FIG. 4.

### DETAILED DESCRIPTION

Various exemplary embodiments are now described more thoroughly with reference to the accompanying drawings, which depict some exemplary embodiments. The thickness dimensions of lines, layers and/or regions may be depicted in an exaggerated manner in the figures for the sake of clarity.

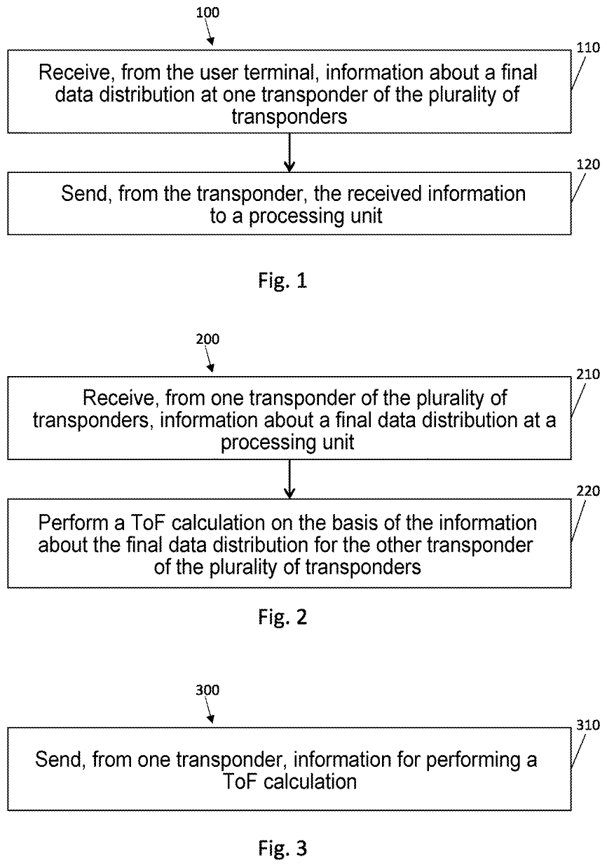

FIG. 1 shows a schematic representation of an example of a method 100 (in particular for a transponder) for improving a ToF calculation between a user terminal and a plurality of transponders. The method 100 comprises receiving 110, from the user terminal, information about a final data distribution (for example receiving an FDN) at one transponder of the plurality of transponders and sending 120, from the transponder, the received information to a processing unit. A ToF calculation for a plurality of transponders can be improved by virtue of a transponder that has received the information about a final data distribution sending this information to the processing unit, for example another transponder. In particular, it is thus possible for information about a final data distribution, for example a Final_Data message according to the CCC standard, to be distributed between the transponder and the processing unit (also referred to as Final_Data distribution, FDD). FDD allows a Final_Data message (which may in particular be identical for the plurality of transponders), and/or the content thereof, to be distributed between a plurality of transponders or one transponder and a processing unit, for example by way of sending and receiving. By way of example, sending and receiving can take place via a bus interface or wirelessly (for example using UWB, WLAN, mobile radio, Bluetooth, Bluetooth Low Energy, etc.). This allows, by way of example, the accuracy of a range determination between one transponder of the plurality of transponders, for example another transponder that has not received an FDN, and the UE to be improved.

A communication between the transponder and the processing unit can take place via a cable, e.g. a bus of a vehicle, or wirelessly. A communication between a transponder and the UE can take place using UWB, for example. Communication by means of UWB, in particular in the case of a range determination, can result in an identical FDN being sent to the plurality of transponders by the UE. This allows the same FDN to be used for different transponders. FDD can therefore be used to improve a ToF calculation by virtue of there no longer being a need for the FDN to be received by every transponder of the plurality of transponders. In principle, one ToF calculation can be performed for all transponders of the plurality of transponders, so long as at least one transponder has received an FDN.

In particular, FDD allows one ToF calculation to be performed for the plurality of transponders if only one transponder of the plurality of transponders has received an FDN. The transponder that has received the FDN can send it to the processing unit, for example another transponder of the plurality of transponders, a central processor, for example encompassed by a central control unit (ECU) of a vehicle, etc. This allows a ToF calculation to be performed even for another transponder of the plurality of transponders that has not received an FDN. By way of example, the other transponder can receive the FDN from the transponder and independently perform a ToF calculation by means of the FDN. Alternatively, the other transponder can also send information for performing a ToF calculation to the processing unit. The processing unit can then take the information for performing a ToF calculation from the other transponder and the FDN received from the transponder as a basis for performing a ToF calculation for the other transponder.

In one exemplary embodiment, the method 100 can further comprise receiving, from the processing unit, information about a performed ToF calculation. This allows the transponder to be informed about a performed ToF calculation. By way of example, the transponder can therefore terminate sending an FDN and/or sending information for performing a ToF calculation. By way of example, the transponder can also terminate an attempt to receive an FDN. This allows a data transfer between the transponder and the processing unit to be minimized. Alternatively, the information about a performed ToF calculation may be information about a ToF calculation performed in the future. By way of example, the processing unit can send information about obtainment of all the necessary information for ToF calculation to the transponders. This allows an unnecessary double data transfer to be avoided and/or the transponder can terminate an attempt to receive an FDN.

In one exemplary embodiment, the method 100 can further comprise decrypting the received information before it is sent. By way of example, the processing unit may not possess a key for decrypting the FDN, and so the processing unit may not be designed to decrypt an FDN. Instead of sending keys required for this purpose to the processing unit or having the processing unit determine said keys, the transponder that sends the FDN to the processing unit can decrypt it before it is sent. Optionally, following a decryption, the transponder can encrypt a decrypted FDN using a new key that is known to the processing unit and is not identical to the encryption of an FDN for transmission between the UE and the transponder. In particular, the fresh encryption by the transponder can require low security.

In one exemplary embodiment, the method 100 can further comprise sending, from the transponder, information for performing a ToF calculation to the processing unit. By way of example, the transponder may not have received an FDN from the UE. Accordingly, the transponder may not be able to perform a ToF calculation, since at least the FDN required therefor may not have been received. Accordingly, the transponder can send all the other required information, for example a POLL or Final, for the ToF calculation to the processing unit, and so the processing unit can use the information for performing a ToF calculation and the received FDN to perform a ToF calculation for the transponder.

In one exemplary embodiment, the processing unit may be encompassed by another transponder of the plurality of transponders. This allows an already existing processor of the other transponder to be used for ToF calculation for the transponder, as a result of which costs for an implementation can be reduced.

Other details and aspects are mentioned in connection with the exemplary embodiments described below. The exemplary embodiment shown in FIG. 1 can comprise one or more optional additional features that correspond to one or more aspects that have been mentioned in connection with the proposed concept or with one or more exemplary embodiments described below (e.g. FIG. 2-5).

FIG. 2 shows a schematic representation of another example of a method 200 (in particular for a processing unit) for improving a ToF calculation between a user terminal and a plurality of transponders. The method 200 comprises receiving 210, from one transponder of the plurality of transponders, information about a final data distribution at a processing unit, and performing 220 a ToF calculation on the basis of the information about the final data distribution for the other transponder of the plurality of transponders. The method 200 can be carried out in particular by a processing unit. The method 200 may thus be a method that is carried out by a processor that is a counterpart of a processor that carries out the method according to FIG. 1. By way of example, the method according to FIG. 1 can be carried out by a first transponder that exchanges an FDN with a second transponder, or sends it to the second transponder; that is to say that the second transponder can then carry out the method 200, in particular. Receiving 210 the FDN allows the processing unit to perform a ToF calculation, for example for itself, if the processing unit is one transponder of the plurality of transponders.

A processing unit may, in particular, be encompassed by or correspond to one transponder of the plurality of transponders or an ECU of a vehicle.

In one exemplary embodiment, the method 200 can further comprise sending, from the processing unit, information about the performed ToF calculation to one transponder of the plurality of transponders. This allows the processing unit to inform the transponder that a ToF calculation has been performed for the transponder. By way of example, this allows the transponder to terminate an attempt to receive an FDN.

In one exemplary embodiment, the processing unit may be encompassed by another transponder of the plurality of transponders. This allows the ToF calculation to be performed in particular by one transponder of the plurality of transponders, as a result of which costs can be minimized. By way of example, the transponder may be a master transponder that performs a plurality of ToF calculations for a plurality of transponders (for example a ToF calculation of its own and a ToF calculation for the transponder).

In one exemplary embodiment, the method 200 can further comprise receiving, from the transponder, information for performing a ToF calculation at the processing unit. As described above, the information for performing a ToF calculation can comprise, besides the FDN, all the necessary information required for ToF calculation for the transponder. This allows a ToF calculation to be carried out by the processing unit, and thus independently of the transponder.

In one exemplary embodiment, the method 200 can further comprise sending a request for the information about the final data distribution to the transponder of the plurality of transponders. This allows in particular the processing unit to actively request the FDN, for example if the processing unit has not received it from the UE.

Other details and aspects are mentioned in connection with the exemplary embodiments described below and/or above. The exemplary embodiment shown in FIG. 2 can comprise one or more optional additional features that correspond to one or more aspects that have been mentioned in connection with the proposed concept or with one or more exemplary embodiments described above (e.g. FIG. 1) and/or below (e.g. FIG. 3-5).

FIG. 3 shows a schematic representation of another example of a method 300 (for another transponder) for improving a ToF calculation. The method 300 comprises sending, from one transponder, information for performing a ToF calculation to a processing unit. This allows in particular another transponder that has not received an FDN to send other parameters required for a ToF calculation for the transponder to the processing unit. The other transponder may thus be in particular a counterpart of a processing unit. The processing unit may have received an FDN, for example from a transponder that carries out a method according to FIG. 1. On the basis of this FDN and the information for performing a ToF calculation from the other transponders, the processing unit can then perform a ToF calculation for the other transponder.

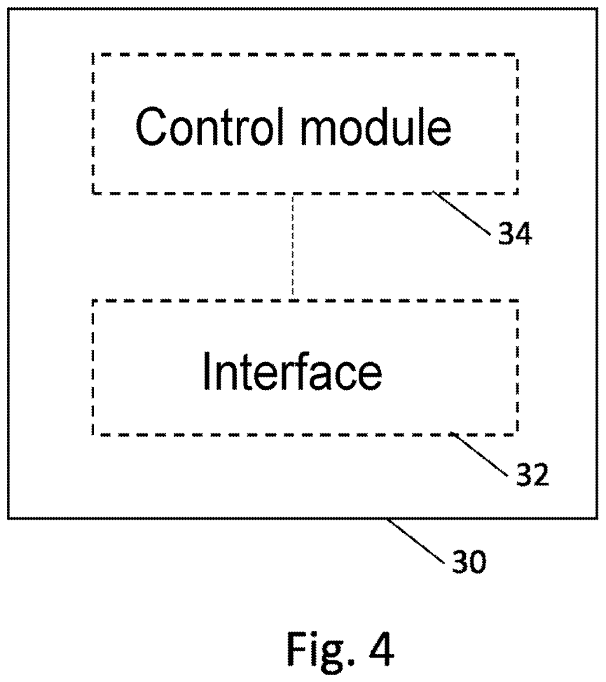

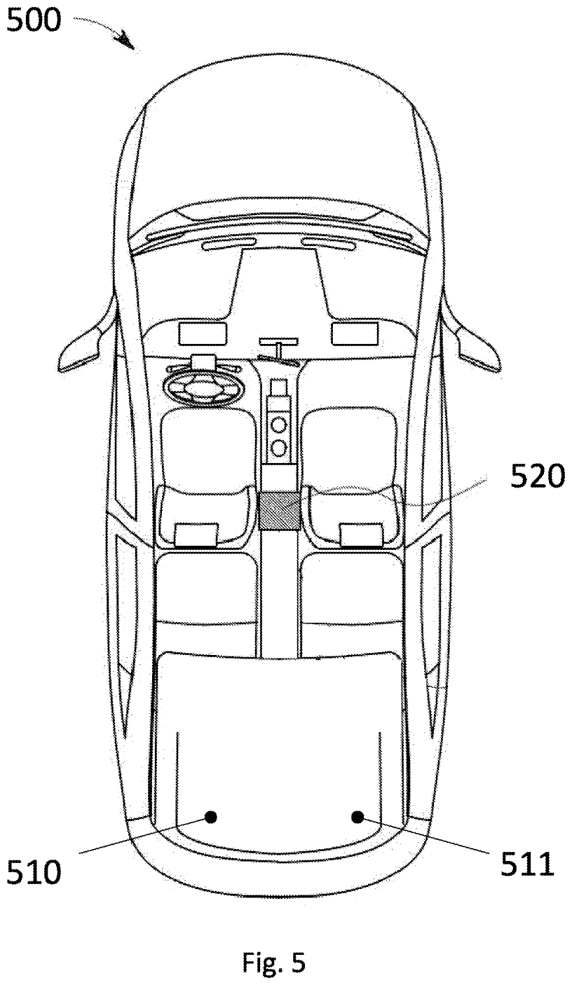

Other details and aspects are mentioned in connection with the exemplary embodiments described below and/or above. The exemplary embodiment shown in FIG. 3 can comprise one or more optional additional features that correspond to one or more aspects that have been mentioned in connection with the proposed concept or with one or more exemplary embodiments described above (e.g. FIG. 1-2) and/or below (e.g. FIG. 4-5).

FIG. 4 shows a block diagram of an exemplary embodiment of an apparatus 30 for improving a ToF calculation. The apparatus 30 comprises one or more interfaces 32 for communication with other communication devices (for example a processing device that can carry out a method according to FIG. 2 and a user terminal for receiving an FDN; a transponder that can carry out a method according to FIG. 1, etc.). The apparatus 30 further comprises a control module 34 that is designed to carry out at least one of the methods described herein, for example the method described with reference to FIG. 1, FIG. 2 or FIG. 3. Other exemplary embodiments are a vehicle having an apparatus 30. In one exemplary embodiment, the processing unit may be encompassed by, or may be, a central computing unit of the vehicle. In particular, the ECU may not be designed to receive an FDN from a UE. Forwarding of the FDN by a transponder permits a ToF calculation by the processing unit.

The one or more interfaces 32 can correspond for example to one or more inputs and/or one or more outputs for receiving and/or transmitting information, for instance in digital bit values, on the basis of a code, within a module, between modules, or between modules of different entities. The at least one or more interfaces 32 may be designed for example to use a (radio) network or a local connecting network to communicate with other network components.

As depicted in FIG. 4, the one or more interfaces 32 are coupled to the respective control module 34 of the apparatus 30. In examples, the apparatus 30 can be implemented by one or more processing units, one or more processing devices, an arbitrary means for processing, e.g. a processor, a computer or a programmable hardware component that can be operated using appropriately adapted software. Similarly, the described functions of the control module 34 can also be implemented in software that is then executed on one or more programmable hardware components. Such hardware components may be a multipurpose processor, a digital signal processor (DSP), a microcontroller, etc. The control module 34 may be able to control the one or more interfaces 32, and so any data transmission that takes place via the one or more interfaces 32 and/or any interaction in which the one or more interfaces 32 may be involved can be controlled by the control module 34.

In exemplary embodiments, the control module 34 can correspond to an arbitrary controller or processor or to a programmable hardware component. By way of example, the control module 34 may also be realized as software that is programmed for an applicable hardware component. In this respect, the control module 34 may be implemented as programmable hardware with appropriately adapted software. This can involve the use of arbitrary processors, such as digital signal processors (DSPs). Exemplary embodiments are not limited to one particular type of processor. Arbitrary processors or multiple processors are conceivable for implementing the control module 34.

In one embodiment, the apparatus 30 can comprise a memory and at least one control module 34 that is coupled to the memory in a functional manner and configured such that it carries out the method described below.

In examples, the one or more interfaces 32 can correspond to any means for obtaining, receiving, transmitting or delivering analog or digital signals or information, e.g. any connection, contact, pin, register, input connection, output connection, conductor, track, etc., that permits a signal or information to be delivered or obtained. The one or more interfaces 32 may be wireless or wired and may be configured such that they can communicate with other internal or external components, e.g. can send or receive signals or information.

In at least some exemplary embodiments, the vehicle can correspond for example to a land vehicle, a watercraft, an aircraft, a rail vehicle, a road vehicle, a car, a bus, a motorcycle, an all-terrain vehicle, a motor vehicle or a truck. The control module may be part of a control unit of the vehicle, for example.

Other details and aspects are mentioned in connection with the exemplary embodiments described below and/or above. The exemplary embodiment shown in FIG. 4 can comprise one or more optional additional features that correspond to one or more aspects that have been mentioned in connection with the proposed concept or with one or more exemplary embodiments described above (e.g. FIG. 1-3) and/or below (e.g. FIG. 5).

FIG. 5 shows a vehicle 500 having an apparatus according to FIG. 4. The vehicle has a plurality of transponders 510, 511 and an ECU 520.

As an FDN requires a higher link budget than other messages exchanged between the transponder 510, 511 and the UE for ToF calculation, there is a relatively high probability of an FDN not being able to be received. As each transponder 510, 511 can use the same FDN, it may be sufficient for only one transponder 510, 511 of the plurality of transponders to obtain the FDN and then distribute it, that is to say perform an FDD. FDD can permit a ToF calculation to be performed for a transponder that has not received an FDN. In principle, there are a multiplicity of options for performing an FDD. A selection without limitation is presented hereinbelow.

By way of example, each transponder 510, 511 can perform its own individual ToF calculation. This requires for example an FDN (comprising T_{round1,1} . . . T_{round1,N}, Tₜₒₜₐₗ) and the T_{reply1,i}, T_{round2,i} (T_{reply1,i} processing time of the responder; T_{round1,1}/Tₜₒₜₐₗ (total) round-trip time measured by the initiator) transponder time intervals (information for performing a ToF calculation). The results can be sent to a central control unit, for example to the ECU 520. By way of example, sending can take place via a bus of the vehicle 500, wirelessly, for example using UWB, WLAN, etc.

By way of example, the transponder 511 may not have received the FDN and may therefore not be able to perform its ToF calculation. The transponder 510 may have received the FDN, on the other hand.

The transponder 511 can then receive the FDN from the transponder 510 (for example by way of a broadcast message) and use it to perform a ToF calculation of its own. This allows in particular faster distribution of the FDN to be attained. Furthermore, faster processing can be achieved, since in particular no decryption step and/or second encryption step is necessary because the transponder 511 can decrypt the FDN.

Optionally, the transponder 510 can decrypt the FDN before it is sent, for example if the FDN is sent to the ECU 520, which may not have a key for decrypting the FDN. Additionally, following a decryption, the transponder 510 can encrypt the FDN using a key that is known to the ECU 520. This allows an ECU 520 to have a smaller number of AES key slots (in the secure RAM), as a result of which costs can be reduced.

Preferably, if the number of buses is equal to one, the FDN will be sent by means of the one bus. Alternatively, if the number of buses is greater than one, the FDN can also be sent via a plurality of buses, as a result of which an FDD can be performed and a ToF calculation can be improved by the FDD. Wireless sending of the FDN from the transponder 510 may be advantageous if the number of buses used for sending is greater than one, as sending an FDD via a plurality of buses can cause an additional delay for the ToF calculation.

Optionally (e.g. if the ECU 520 is switched off) or alternatively, one transponder 510, 511 of the plurality of transponders can act as the master transponder. The master transponder can then perform a ToF calculation for all transponders 510, 511. This requires for example an FDN (comprising T_{round1,1} . . . T_{round1,N}, Tₜₒₜₐₗ) and the T_{reply1,1} . . . T_{reply1,N}, T_{round2,1} . . . T_{round2,N} transponder time intervals of the individual transponders. The results can be sent to a central control unit, for example to the ECU 520.

By way of example, the transponder 511 may be the master transponder 511 and may not have received the FDN, and may therefore not be able to perform a ToF calculation. The transponder 510 may have received the FDN, on the other hand.

The master transponder 511 can then receive the FDN from the transponder 510 (for example by way of a unicast message, for example by selecting one antenna of an antenna array, beamforming, etc.) and use it to perform a ToF calculation of its own. Optionally, the master transponder 511 may have received transponder time intervals from another transponder. The transponder time intervals and the FDN can then be used by the master transponder 511 to perform a ToF calculation for the other transponder.

Optionally, the transponder 510 can decrypt the FDN before it is sent. Additionally, following a decryption, the transponder 510 can encrypt the FDN using a key that is known to the master transponder 511. This allows a master transponder 511 to have a smaller security RAM, as a result of which costs can be reduced.

Alternatively, the ECU 520 can be used as a central control unit for ToF calculation. Each transponder 510, 511 can then send the available data for a ToF calculation to the ECU 520, for example transponder interval times and, if received, an FDN. Analogously to the master transponder, this requires for example an FDN (comprising T_{round1,1} . . . T_{round11,N}, Tₜₒₜₐₗ) and the T_{reply1,1} . . . T_{reply1,N}, T_{round2,1} . . . T_{round2,N} transponder time intervals of the individual transponders.

The ECU 520 can receive the FDN from the transponder 510 and/or the transponder 511 (for example by way of a unicast message, for example by selecting one antenna of an antenna array, beamforming, etc.). Furthermore, the ECU 520 can receive the transponder time intervals from each transponder 510, 511 and use them to perform a ToF calculation for each transponder 510, 511. Preferably, the FDN can be decrypted by the sending transponder, and so calculation of keys for the decryption of the FDN by the ECU 520 is not necessary.

Other details and aspects are mentioned in connection with the exemplary embodiments described above. The exemplary embodiment shown in FIG. 5 can comprise one or more optional additional features that correspond to one or more aspects that have been mentioned in connection with the proposed concept or with one or more exemplary embodiments described above (e.g. FIG. 1-4).

Other exemplary embodiments are computer programs for carrying out one of the methods described herein when the computer program runs on a computer, a processor or a programmable hardware component. Depending on determined implementation requirements, exemplary elements of the invention may be implemented in hardware or in software.

The implementation can be carried out using a digital storage medium, for example a floppy disk, a DVD, a Blu-Ray disk, a CD, a ROM, a PROM, an EPROM, an EEPROM or a flash memory, a hard disk or another magnetic or optical memory storing electronically readable control signals that can interact or do interact with a programmable hardware component such that the respective method is carried out.

A programmable hardware component may be formed by a processor, a computer processor (CPU=Central Processing Unit), a graphics processor (GPU=Graphics Processing Unit), a computer, a computer system, an application-specific integrated circuit (ASIC), an integrated circuit (IC), a system on chip (SOC), a programmable logic element or a field programmable gate array (FPGA) with a microprocessor.

The digital storage medium may therefore be machine- or computer-readable. Some exemplary embodiments thus comprise a data carrier that has electronically readable control signals capable of interacting with a programmable computer system or a programmable hardware component such that one of the methods described herein is carried out. One exemplary embodiment is therefore a data carrier (or a digital storage medium or a computer-readable medium) on which the program for carrying out one of the methods described herein is recorded.

In general, exemplary embodiments of the present invention may be implemented as a program, firmware, a computer program or computer program product with a program code or as data, the program code or the data being effective to the extent of carrying out one of the methods when the program runs on a processor or a programmable hardware component. The program code or the data may for example also be stored on a machine-readable carrier or data carrier. The program code or the data may be present, inter alia, as source code, machine code or byte code and as some other intermediate code.

The exemplary embodiments described above are merely an illustration of the principles of the present invention. It goes without saying that modifications and variations of the arrangements and details described herein will become apparent to others skilled in the art. Therefore, the intention is that the invention shall be restricted only by the scope of protection of the patent claims that follow and not by the specific details that have been presented on the basis of the description and the explanation of the exemplary embodiments herein.

### LIST OF REFERENCE SIGNS

apparatus
32 interface
34 control module
100 method for improving a time-of-flight calculation
110 receive, from the user terminal, information about a final data distribution
120 send, from the transponder, the received information
200 method for improving a time-of-flight calculation
210 receive information about a final data distribution
220 perform a ToF calculation on the basis of the information
300 method for improving a time-of-flight calculation
310 send, from one transponder, information relating to the performance
500 vehicle
510, 511 transponder
520 central control unit

1.-15. (canceled)

16. A method for improving a time-of-flight (ToF) calculation between a user terminal and a plurality of transponders, comprising:
receiving, from the user terminal, information about a final data distribution at a first transponder of the plurality of transponders; and
sending, from the first transponder, the information about the final data distribution to a processing unit.

17. The method as claimed in claim 16, further comprising:
receiving, from the processing unit, information about a performed ToF calculation.

18. The method as claimed in claim 17, further comprising:
before sending the information about the final data distribution, decrypting the information about the final data distribution.

19. The method as claimed in claim 16, further comprising:
before sending the information about the final data distribution, decrypting the information about the final data distribution.

20. The method as claimed in claim 16, further comprising:
sending, from the transponder, information for performing a ToF calculation to the processing unit.

21. The method as claimed in claim 16, wherein:
the processing unit is encompassed by another transponder of the plurality of transponders.

22. A non-transitory storage medium containing a computer program for carrying out the method as claimed in claim 16 when the computer program runs on a computer, a processor or a programmable hardware component.

23. An apparatus for improving a ToF calculation, comprising:
one or more interfaces for communication with other communication devices; and
a control module configured to carry out the method as claimed in claim 16.

24. A vehicle having an apparatus as claimed in claim 23.

25. The vehicle as claimed in claim 24, wherein
the processing unit is encompassed by a central computing unit of the vehicle.

26. A method for improving a time-of-flight (ToF) calculation between a user terminal and a plurality of transponders, comprising:
receiving, from a first transponder of the plurality of transponders, information about a final data distribution at a processing unit; and
performing a ToF calculation based at least in part on the information about the final data distribution for a second transponder of the plurality of transponders.

27. The method as claimed in claim 26, further comprising:
sending, from the processing unit, information about the performed ToF calculation to a transponder of the plurality of transponders.

28. The method as claimed in claim 26, wherein the processing unit is encompassed by another transponder of the plurality of transponders.

29. The method as claimed in claim 26, further comprising:
receiving, from the first transponder, information for performing a ToF calculation at the processing unit.

30. The method as claimed in claim 29, further comprising:
sending a request for the information about the final data distribution to the first transponder of the plurality of transponders.

31. The method as claimed in claim 26, further comprising:
sending a request for the information about the final data distribution to the first transponder of the plurality of transponders.

32. An apparatus for improving a ToF calculation, comprising:
one or more interfaces for communication with other communication devices; and
a control module configured to carry out the method as claimed in claim 26.

33. A vehicle having an apparatus as claimed in claim 32.

34. A method for improving a time-of-flight (ToF) calculation between a user terminal and a plurality of transponders, comprising:
sending, from a first transponder, information for performing a ToF calculation to a processing unit.
